(19) United States
(12) Patent Application Publication
(10) Pub. No.: US 2004/0247413 A1
(43) Pub. Date: Dec. 9, 2004

(54) Fastener and its handling tool

(76) Inventor: Tae-Hwan Ha, Seoul (KR)

Correspondence Address: Marshall Gerstein & Borun, 6300 Sears Tower, 233 South Wacker Drive, Chicago, IL, 60606-6357, US

(21) Appl. No.: 10/492,488

(22) PCT Filed: Oct. 7, 2002
(86) PCT No.: PCT/KR02/01866

(30) Foreign Application Priority Data
Oct. 12, 2001 (KR) 2001-0031157 U
Oct. 12, 2001 (KR) 2001-0031159 U
Oct. 12, 2001 (KR) 2001-0031160 U

(51) Int. Cl. F16B 23/00

(52) U.S. Cl. 411/402

(57) ABSTRACT

The invention provides a fastener whose torque-receiving circumference is either circular or polygonal with more than twelve angles. In order to manipulate such a fastener, a wrench and a socket for a socket wrench have a housing having an interior space, and a fastening unit disposed in the interior space of the housing, wherein the fastening unit includes a plurality of sprags and ends of the sprags each protrude toward the interior space of the housing forming an arc, are provided.

### BACKGROUND OF THE INVENTION

(a) Field of the Invention

The present invention relates to fasteners such as bolts and nuts, and to a handling tool such as a wrench for manipulating such fasteners.

(b) Description of the Related Art

Fasteners such as bolts and nuts are widely used in order to conjoin separate parts, and the fasteners have a polygonal circumference to receive torque.

For example, a bolt is usually provided with a bolt head, and the bolt head is usually in a polygonal shape in order to receive tightening/loosening torque. As for nuts, the exterior shape thereof is also usually in such a polygonal shape.

According to the prior art, a hexagonal shape is the most popular for the circumference of a fastener, and sometimes tetragonal or twelve-angled shapes are also found. However, polygonal shapes having more than twelve angles are not used because it is believed that the edges cannot endure or transmit sufficient torque.

A fastener is tightened or loosened in order to conjoin or disjoin parts in an assembly by applying torque to the fastener, and more particularly, to edges of the fastener of a polygonal shape.

Various types of wrenches have been devised and used in order to manipulate, that is, to tighten or to loosen, such fasteners. As well as simple ones such as open end wrenches and box end wrenches, more complex ones such as ratchet -wrenches and socket wrenches may be examples thereof.

However, a fastener of such a polygonal circumference and a wrench for manipulating such a fastener has the following problems.

Firstly, the number of positions in which a wrench can be engaged with a fastener is limited, according to how many angles the fastener has at its circumference. For example, if the circumference of a bolt head is hexagonal, there are only six positions, each separated by 60 degrees, in which the wrench can be engaged with the bolt.

Although it is known that the number of positions can be doubled for a socket wrench if sockets for the socket wrench are specially designed, this does not sufficiently increase the possible ways of engagement of the wrench and a fastener.

FIG. 1 shows a state in which a specially designed socket 110 is connected to a fastener 120 with a hexagonal circumference, according to the prior art.

As can be seen in FIG. 1, the number of positions in which the socket 110 can be engaged with the fastener 120 is doubled, but it is limited to twelve.

In order to further increase the number of engaging positions, the area of the socket 110 that contacts the fastener 120 must be decreased, however, in this case, the strength and durability of the socket or wrench is substantially deteriorated, and therefore such a case is believed to be impractical.

Secondly, as shown in FIG. 2, when a wrench 220 is connected to a fastener 210 with a polygonal circumference, a clearance “d” is formed therebetween, and the clearance causes the following problems: (1) space for operating the wrench 220 easily becomes insufficient when fasteners 210 are congested or when a lot of obstacles are located nearby; and (2) when the clearance “d” is wide, edges 215 of the fastener 210 contact inner walls 225 of the wrench 220 with some inclined angle, and therefore, too much force is concentrated on the edges 215 and the edges 215 are easily worn.

Occurrence of such clearance “d” is common rather than exceptional, because each of fasteners and wrenches are made to a tolerance, and various unit systems to specify such fasteners and wrenches are used such as “mm” units and “inch” units.

As well as the clearance problem, conventional ratchet wrenches, according to their mechanical structure, have free play even when the 15 wrench is tightly fitted to a fastener. Therefore, it is difficult to manipulate a fastener in a circumstance in which a space to rotate the wrench is small.

Thirdly, the circumference of a fastener, for example, a head of a bolt, must be larger than the diameter of its threaded portion in order to provide sufficient strength of the fastener to receive tightening/loosening torque. Therefore, a lot of materials must be used to make the fastener, the manufacturing process is complicated, and accordingly, the manufacturing cost is increased.

Sometimes, fasteners are heat-treated in order to provide sufficient strength, which also increases manufacturing cost and makes the manufacturing process more complicated.

### SUMMARY OF THE INVENTION

Therefore, the motivation for the present invention is to solve the above problems and accordingly to provide:

a wrench and a socket for a socket wrench that have non-limiting advantages of supplying sufficient torque to a fastener of round or more than twelve-angled circumference and/or reduced free play; and

a fastener that has non-limiting advantages of lower material used for its manufacturing, simpler manufacturing process, and/or lower manufacturing cost.

An exemplary fastener useful with the present invention has circumference for receiving torque and the circumference is either circular or polygonal with more than twelve-angles.

An exemplary bolt useful with the present invention includes a body having a threaded portion and a bolt head extended from the body, wherein a circumference of the bolt head is either circular or polygonal with more than twelve-angles.

An opposite side of the bolt head, opposite to the body, is preferably flat or convex, and a decoration groove may be formed on the opposite side of the bolt head.

An exemplary nut useful with the present invention has a threaded hole adapted to receive a bolt, and a circumference of the nut around an axis of the threaded hole is circular or polygonal with more than twelve-angles. The circumference is preferably formed throughout a width of the nut.

An exemplary wrench useful with the present invention includes: a housing having an interior space; a handle for supplying torque to the housing; and one or more fastening units disposed in the interior space of the housing, wherein the fastening unit comprises a plurality of sprags, and ends of the sprags, each protruding toward the interior space of the housing, form an arc.

Preferably, the fastening unit further comprises a plate spring for positioning the sprags, wherein both lateral sides of the sprag are concave, a plurality of receiving holes are formed at the plate spring, each sprag is inserted through a receiving hole of the plate spring, and a supporting projection is formed at the receiving hole of the plate spring such that the support projection supports the concave lateral side.

Preferably, at least one end of each sprag is asymmetrically convex, and also preferably, at least one end of each sprag is symmetrically convex.

Upper and lower edges of at least one end of each sprag are preferably round.

According to a preferable further embodiment, the fastening unit further includes an inner ring and an outer ring for positioning the sprags, a plurality of receiving holes are respectively formed at the inner ring and the outer ring, the inner ring is disposed toward the interior space from the plate spring; and the outer ring is disposed toward the opposite of the interior space from the plate spring.

In a further preferred embodiment, the interior space of the housing and the fastening unit are circularly formed, and the arc formed by the ends of the sprags is a full circle.

In another further preferred embodiment, the interior space of the housing is opened to an exterior of the housing, and the fastening unit is provided as a pair, each being disposed in the interior space of the housing, facing each other.

It is further preferable to include one or more elastic members producing an elastic force such that a space between exterior ends of the pair of fastening units is widened.

In a further preferable embodiment, the elastic member is provided in at least a pair, and each of the pair of the elastic members is respectively abutted by each of the fastening units, and each of the pair of the elastic members is abutted by the housing.

An exemplary socket for a socket wrench useful with the present invention includes a housing having an interior space, and a circular fastening unit disposed in the interior space of the housing, wherein the fastening unit comprises a plurality of sprags, and ends of the sprags, each protruding toward the interior space of the housing, form a circle.

In a further preferred embodiment, at least one end of each sprag is asymmetrically convex, and

In a further preferred embodiment, upper and lower edges of at least one end of each sprag are round.

### BRIEF DESCPRIPTION OF THE DRAWINGS

The accompanying drawings, which are incorporated in and constitute a part of the specification, illustrate an embodiment of the invention, and, together with the description, serve to explain the principles of the invention:

FIG. 1 shows a state in which a specially designed socket is connected to a fastener with a hexagonal circumference, according to the prior art;

FIG. 2 shows clearance between a wrench and a fastener with a polygonal circumference according to the prior art;

FIG. 3 shows perspective views of a bolt and a nut according to a first preferred embodiment of the present invention;

FIG. 4 shows perspective views of a bolt and a nut according to a second preferred embodiment of the present invention;

FIG. 5 is an exploded perspective view of a wrench according to a third preferred embodiment of the present invention;

FIG. 6 is a partial cross-sectional view of a wrench according to a third preferred embodiment of the present invention, the cross-section being perpendicular to an axis of its housing;

FIG. 7 is an exploded perspective view of a fastening unit of a wrench according to a third preferred embodiment of the present invention;

FIG. 8 illustrates planar and lateral views of a sprag of a wrench according to a third or fifth preferred embodiment of the present invention;

FIG. 9 illustrates a power stroke of a wrench according to a third preferred embodiment of the present invention; and

FIG. 10 illustrates a free stroke of a wrench according to a third preferred embodiment of the present invention.

FIG. 11 is a perspective view of a socket for a socket wrench according to a fourth preferred embodiment of the present invention;

FIG. 12 is an exploded perspective view of a wrench according to a fifth preferred embodiment of the present invention;

FIG. 13 is a partial cross-sectional view of a wrench according to a fifth preferred embodiment of the present invention, the cross-section being perpendicular to an axis of its housing;

FIG. 14 shows a wrench according to a fifth preferred embodiment of the present invention, when it is not engaged with a fastener; and

FIG. 15 shows a wrench according to a fifth preferred embodiment of the present invention, when it is engaged with a fastener.

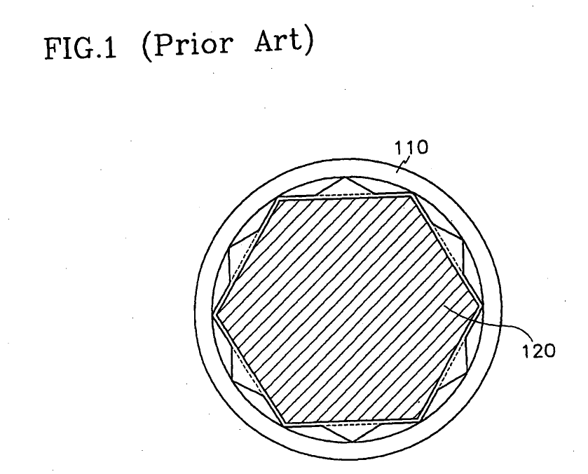

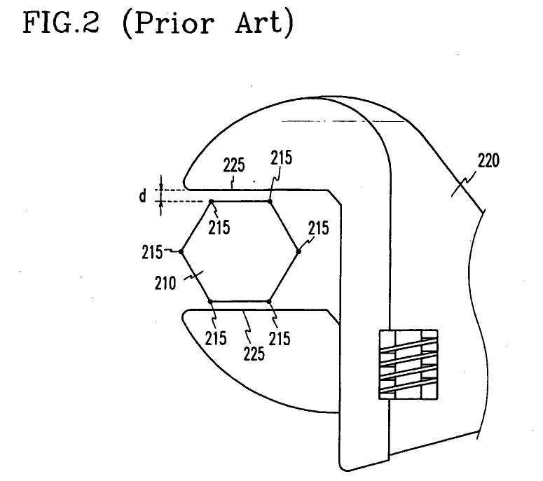

### DETAILED DESCRIPTION OF THE PREFERRED EMBODIMENTS

A preferred embodiment of the present invention will hereinafter be described in detail with reference to the accompanying drawings.

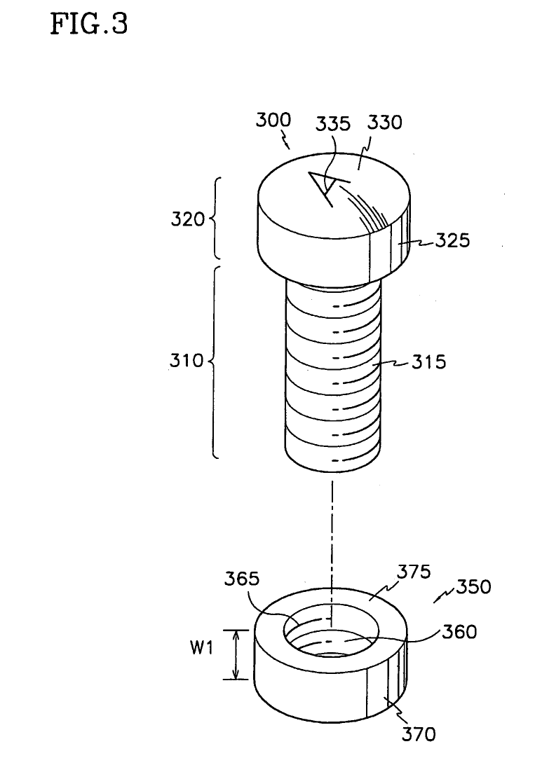

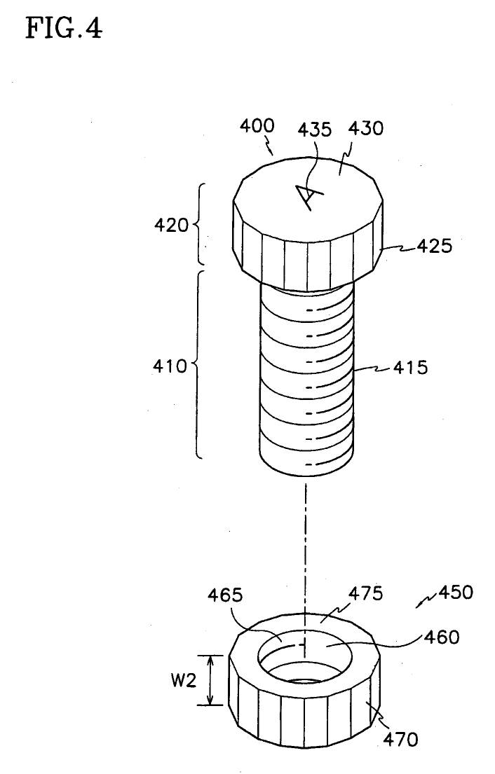

Firstly, preferred embodiments of a fastener of the present invention are hereinafter described in detail with reference to FIG. 3 and FIG. 4.

Fasteners of preferred embodiments of the present invention can be realized as bolts and nuts, and FIGS. 3 and 4 respectively show such embodiments of fasteners of the present invention.

As shown in FIG. 3, a bolt 300 according to a first embodiment of the present invention includes a body 310 having a threaded portion 315, and a bolt head 320 extended from the body 310, where a circumference 325 of the bolt head 320 is formed to be circular.

An opposite side 330 of the bolt head 320 that is opposite to the body 310 may be in any form such as convex, flat, and concave, however, it is preferably convex or flat. FIG. 3 illustrates the opposite side 330 to be convex.

A decoration groove 335 may be formed on the opposite side 330. The decoration groove 335 may be in any form and FIG. 3 illustrates a character “A” as the decoration groove 335.

As shown in FIG. 3, a nut 350 according to a first embodiment of the present invention has a threaded hole 360 for receiving a bolt, and a circumference 370 of the nut 350 around an axis 375 of the threaded hole 360 is circular. The reference number 365 refers to a thread formed on an inner surface of the nut 350.

The circumference 370 may be partially formed within a width W1 of the nut 350, however, is preferably formed throughout the width W1.

As shown in FIG. 4, a bolt 400 according to a second embodiment of the present invention includes a body 410 having a threaded portion 415, and a bolt head 420 extended from the body 410, where a circumference 425 of the bolt head 420 is formed in a polygonal shape of more than twelve angles. FIG. 4 illustrates the circumference 425 to be of sixteen angles.

An opposite side 430 of the bolt head 420 that is opposite to the body 410 may be in any form such as convex, flat, and concave, however, it is preferably convex or flat. FIG. 4 illustrates the opposite side 430 to be convex.

A decoration groove 435 may be formed on the opposite side 430. The decoration groove 435 may be in any form, and FIG. 4 illustrates a character “A” as the decoration groove 435.

As shown in FIG. 4, a nut 450 according to a second embodiment of the present invention has a threaded hole 460 for receiving a bolt, and a circumference 470 of the nut 450 around an axis 475 of the threaded hole 460 is circular. FIG. 4 illustrates the circumference 470 to be of sixteen angles. The reference number 465 refers to a thread formed on an inner surface of the nut 450.

The circumference 470 may be partially formed within a width W2 of the nut 450, however, is preferably formed throughout the width W2.

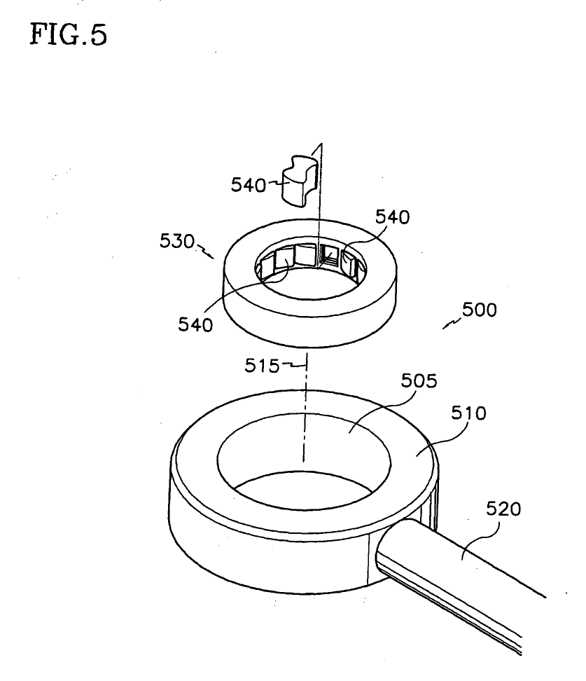

A wrench according to a third preferred embodiment of the present invention is hereinafter described in detail with reference to FIGS. 5-8.

FIG. 5 shows an exploded perspective view of a wrench 500 according to a third preferred embodiment of the present invention.

As shown in FIG. 5, the wrench 500 of the third embodiment of the present invention includes a housing 510 having an interior space 505, a handle 520 for supplying torque to the housing 510, and a fastening unit 530 disposed in the interior space 505 of the housing 510.

FIG. 5 shows that the handle 520 is preferably elongated from the housing 510 in the direction perpendicular to an axis 515 of the housing, but the elongated direction is not necessarily limited to that only, and it is also preferable that the handle 520 forms a predetermined angle with the axis 515 or is even elongated in the direction of the axis 515.

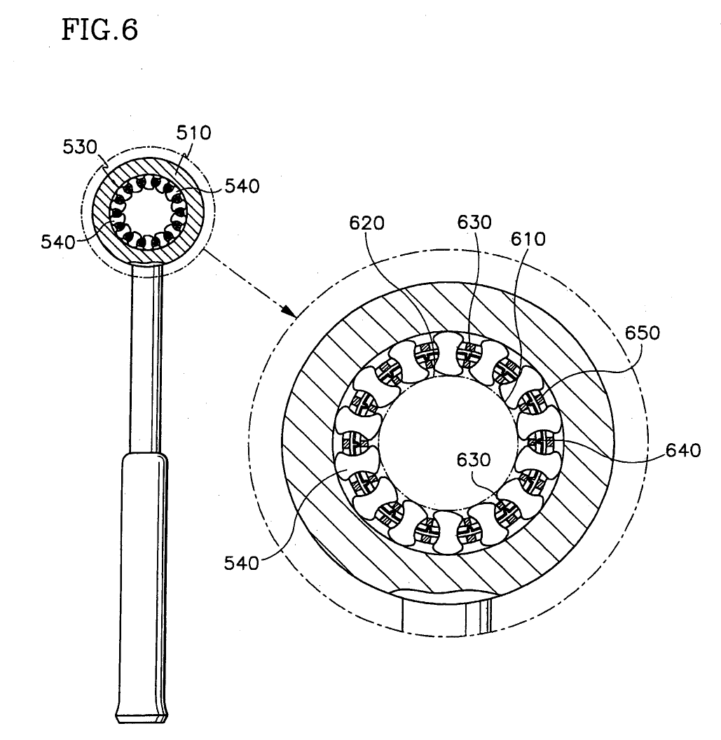

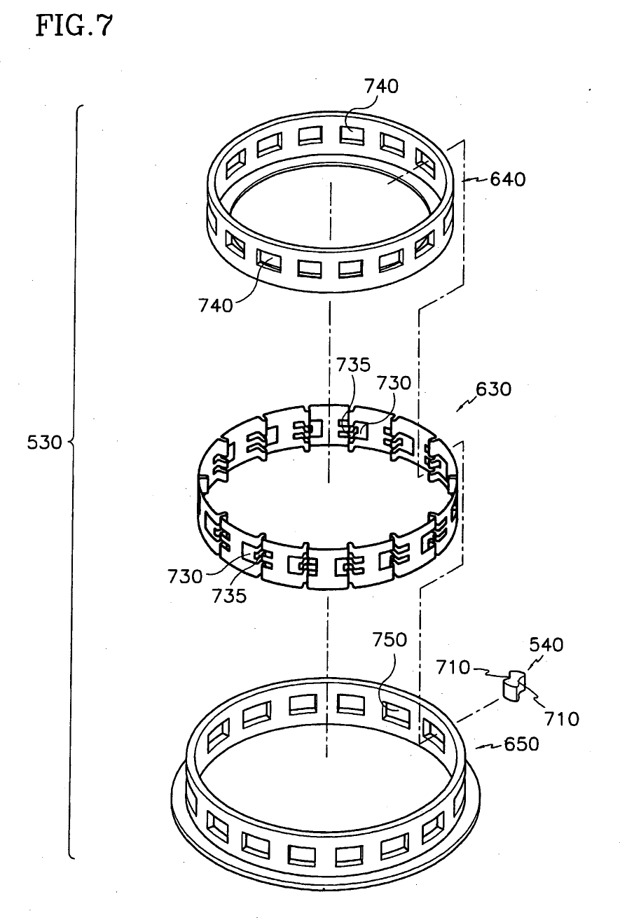

The fastening unit 530 includes a plurality of sprags 540, whose overall scheme is shown in FIG. 5, and a further detailed scheme of the fastening unit 530 is illustrated in FIGS. 6 and 7.

FIG. 6 is a partial cross-sectional view of a wrench 500 according to a third preferred embodiment of the present invention, the cross-section being perpendicular to an axis 515 of its housing 510.

As shown in FIG. 6, ends 610 of the sprags 540, each end 610 protruding toward the interior space 505 of the housing 510, form an arc 620.

In more detail, according to the third embodiment, the interior space 505 of the housing 510 and the fastening unit 530 are circularly formed, and the arc 620 formed by the ends 610 of the sprags 540 is a full circle.

The fastening unit 530 further includes a plate spring 630, an inner ring 640, and an outer ring 650, each for positioning the sprags 540.

The plate spring 630 is disposed in the vicinity of a central line of the sprags 540, the inner ring 640 is disposed toward the interior space 505 from the central line, and the outer ring 650 is disposed toward the opposite of the interior space 505 from the central line, such that they are disposed in the order of the inner ring 640, the plate spring 630, and the outer ring 650 from the center of the space 505.

The fastening unit 530 is illustrated in an exploded perspective view in FIG. 7, and is described in further detail with reference thereto.

A plurality of receiving holes 730, 740, and 750 are respectively formed, at corresponding positions, at each of the plate spring 630, inner ring 640, and outer ring 650.

When the plate spring 630, the inner ring 640, and the outer ring 650 are assembled, the sprag 540 is inserted into the corresponding holes 730, 740, and 750.

In order to receive the sprag 540, widths of the receiving holes 730, 740, and 750 are formed larger than the width of the sprag 540.

As shown in FIG. 7, both lateral sides 710 of the sprag 540 are concave in the vicinity of its center, and a supporting projection 735 is formed at the receiving hole 730 of the plate spring 630 such that the support projection 735 supports the concave lateral side 710.

Therefore, when the sprag 540 has been inserted into the plate spring 630, the supporting projection 735 supports the concave lateral side 710 and prevents separation of the sprag 540 from the fastening unit 530.

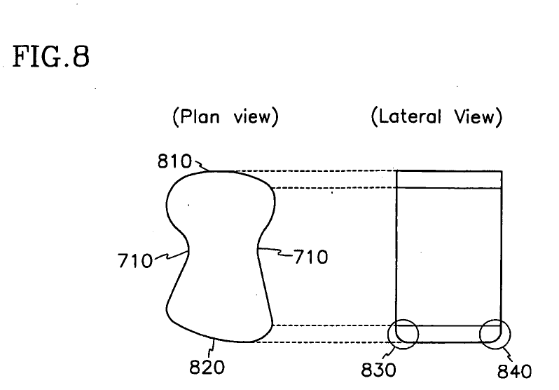

The shape of the sprag 540 is described in further detail with reference to FIG. 8.

FIG. 8 illustrates planar and lateral views of the sprag 540, where an upward direction in FIG. 8 is a direction toward the housing 510, and a downward direction is a direction toward the interior space 505.

As shown in the planar view of FIG. 8, an upper end 810, that is, an end toward the housing 510, is symmetrically convex, and a lower end 820, that is, an end toward the interior space 505, is asymmetrically convex. Accordingly, the length between the upper and lower ends 810 and 820 is varied according to the angle by which the sprag 540 is aligned.

Upper and lower edges 830 and 840 of the lower end 820 of the sprag 540 are rounded such that a fastener such as a bolt and a nut can be easily inserted into the fastening unit 530.

A fastener can be easily inserted into the fastening unit 530 even in the case that the diameter of the circular arc 620 formed by the ends 610 of the sprags 540 is slightly smaller than the circumference of the fastener.

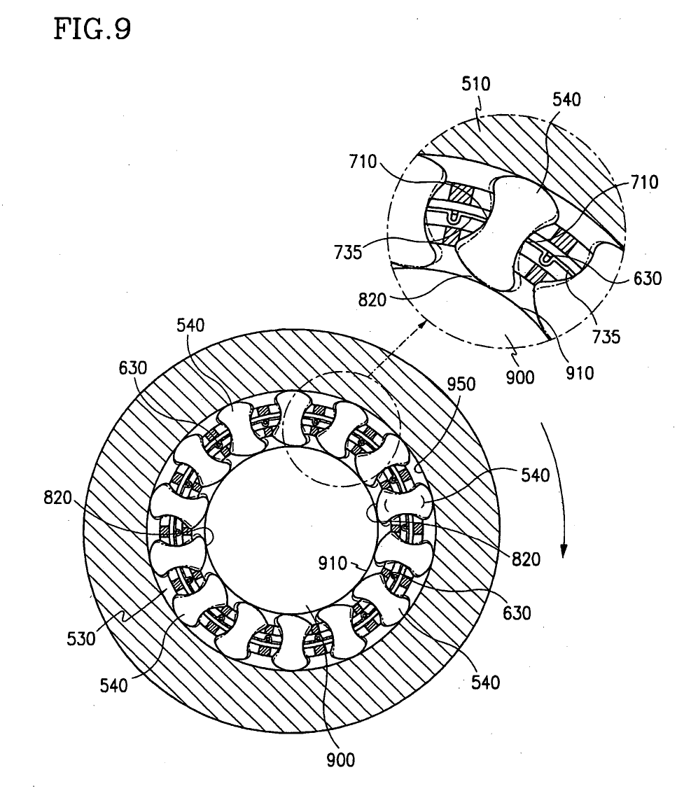

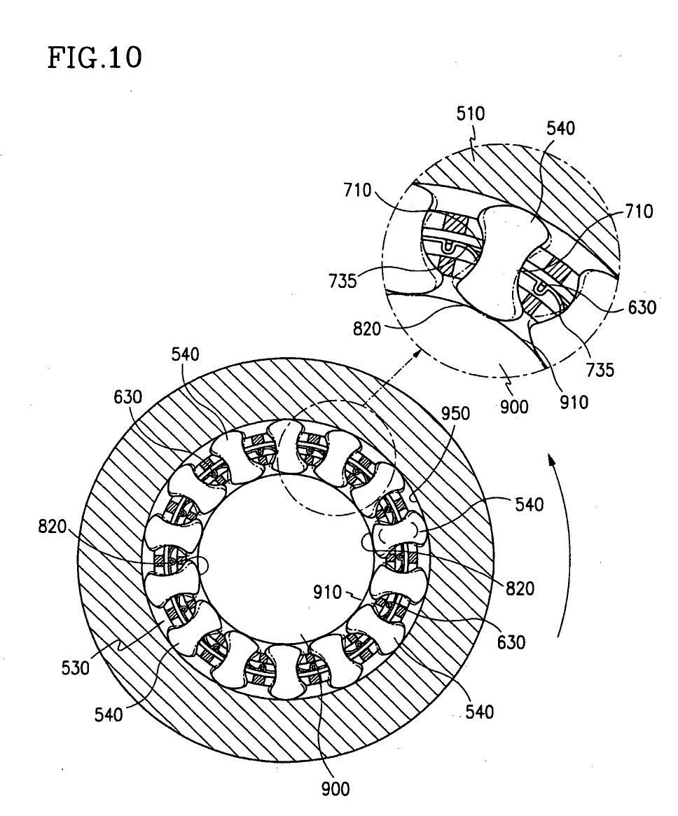

Operation of the wrench 500 of the third embodiment is hereinafter described in detail with reference to FIGS. 9 and 10.

FIG. 9 shows how a fastener can be tightened.

In order to manipulate a fastener 900 using the wrench 500, the fastener 900 is inserted into the fastening unit 530. Accordingly, a circumference 910 of the fastener 900 contacts the ends 820 of the sprags 540, and the ends 810 of the sprags 540 contact an interior surface 950 of the housing 510. The circumference 910 of the fastener 900 is either circular or polygonal with more than twelve angles.

When the wrench 500 is rotated in a clockwise direction as shown in FIG. 9, the sprag 540, being in contact with the circumference 910 of the fastener 900 and the interior surface 950 of the housing 510, receives clockwise rotating force because of the friction of the contact surfaces.

If rotated in the clockwise direction, the distance between the far ends 810 and 820 increases, but the sprag 540 cannot rotate in the clockwise direction because both the housing 510 and the fastener 900 are rigid bodies. Therefore, the sprag 540 becomes more tightly jammed between the housing 510 and the fastener 900.

Therefore, the plurality of sprags 540 hold the fastener 900 with sufficient strength, and they accordingly transmit a sufficiently large torque to the circumference 910 of the fastener 900.

Although FIG. 9 illustrates a case wherein a torque in a clockwise direction is supplied, it also provides an understanding of the case wherein a torque in a counterclockwise direction is applied, because in order to a supply a counterclockwise torque, the wrench 500 can be simply turned over.

According to the operation described above, the fastener 900 can be tightened or loosened.

Such forcing and rotating the fastener 900 by a degree is referred to as a “power stroke” hereinafter. Repeated application of the power stroke to the fastener 900 enables tightening or loosening of the fastener 900 to a desired position.

In order to repeatedly apply the power stroke without disengaging the wrench 500 from the fastener 900, the wrench 500 is rotated in the direction opposite to that of the power stroke (with respect to the example of a power stroke shown in FIG. 9, in a counterclockwise direction). Such rotating of the wrench 500 in the direction reverse to the power stroke is referred to as “free stroke” hereinafter.

Operation of the wrench 500 in the free stroke is hereinafter described in detail with reference to FIG. 10.

When the wrench 500 is rotated in a counterclockwise direction as shown in FIG. 10, the sprag 540, being in contact with the circumference 910 of the fastener 900 and the interior surface 950 of the housing 510, receives counterclockwise rotating force because of the friction of contact surfaces.

Therefore, the sprag 540 is forced to be released from the tightly jammed state between the housing 510 and the fastener 900.

In this case, the supporting projection 735 that supports the concave lateral side 710 of the sprag 540 bends toward the fastener 900 as shown in FIG. 10, and the sprag 540 receives clockwise repositioning torque from the bent projection 735. Accordingly, the sprag 540 keeps in contact with the circumference 910 of the fastener 900 and the interior surface 950 of the housing 510 even when the wrench 500 is rotated in the counterclockwise direction.

Therefore, when the wrench 500 is rotated again in a clockwise direction, no free play of the wrench 500 occurs, and the torque is immediately transmitted to the fastening unit 530 and subsequently to the fastener 900.

Because free play does not occur during repetition of the power stroke and the free stroke, the fastener 900 can be more easily tightened or loosened even when the space for operating the wrench 500 is very small due to nearby obstacles.

The operating mechanism of the fastening unit 530, shown in FIGS. 7-10 and described above with reference thereto, can also be applied to a socket for a socket wrench.

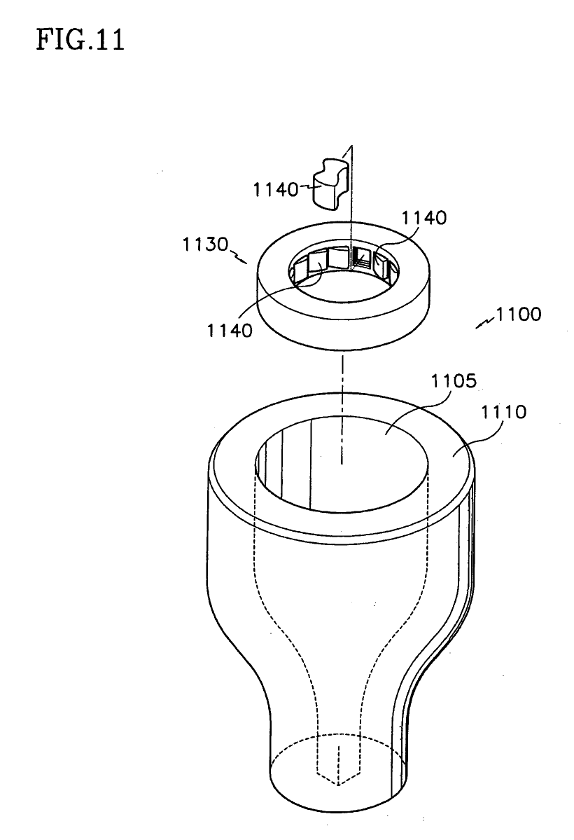

FIG. 11 is a perspective view of a socket 1100 for a socket wrench according to a fourth preferred embodiment of the present invention.

As shown in FIG. 11, a socket 1100 for a wrench socket according to the fourth preferred embodiment of the present invention includes a housing 1110 having an interior space 1105 and a circular fastening unit 1130 disposed in the interior space 1105 of the housing 1110. The fastening unit 1130 includes a plurality of sprags 1140, and ends of the sprags 1140, each protruding toward the interior space 1105 of the housing, form a circle.

The fastening unit 1130 of the socket 1100 of the fourth embodiment of the present invention may have the same structure as the fastening unit 530 of the wrench 500 of the third embodiment, and therefore further detailed description regarding the fastening unit 1130 is not provided here, because a person in the art can obviously understand detailed features of the fastening unit 1130 referring to FIGS. 6-10 and the description referring thereto.

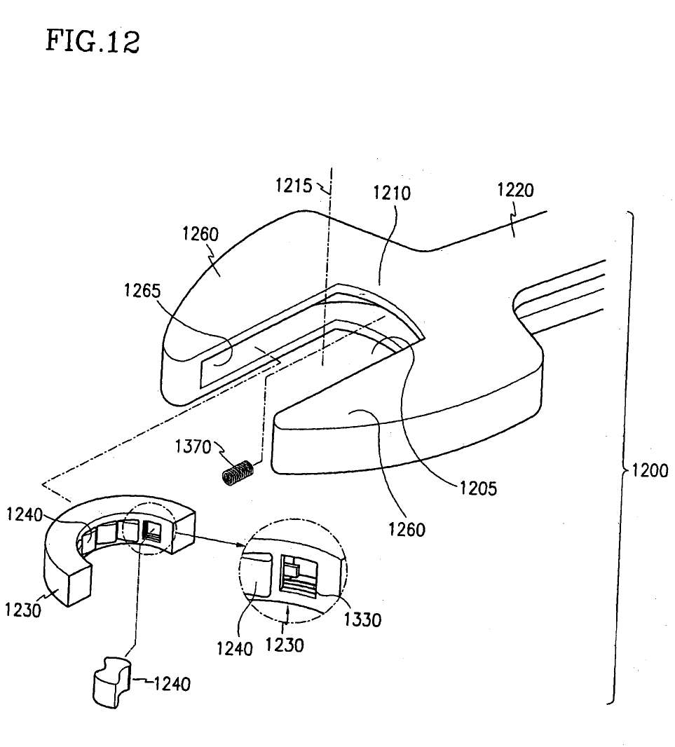

A wrench according to a fifth preferred embodiment of the present invention is hereinafter described in detail with reference to FIGS. 12-15.

FIG. 12 is an exploded perspective view of a wrench 1200 according to the fourth preferred embodiment of the present invention.

As shown in FIG. 12, the wrench 1200 of the fourth embodiment includes a housing 1210 having an interior space 1205, a handle 1220 for supplying torque to the housing 1210, and a fastening unit 1240 disposed in the interior space 1205 of the housing 1210.

The housing 1210 includes a pair of fastening jaws 1260, which face each other, and a receiving area 1265 is formed at each interior of the fastening jaws 1260. The receiving area 1265 is adjacent to the interior space 1205 of the housing 1210, and the interior space 1205 of the housing 1210 is opened to an exterior of the housing 1210 in the direction perpendicular to an axis 1215 of the housing 1210.

Fastening units 1230 are provided as a pair and are disposed in the interior space 1205 of the housing 1210, and more specifically, in the receiving areas 1265 of the fastening jaws 1260, the pair of fastening units 1230 facing each other.

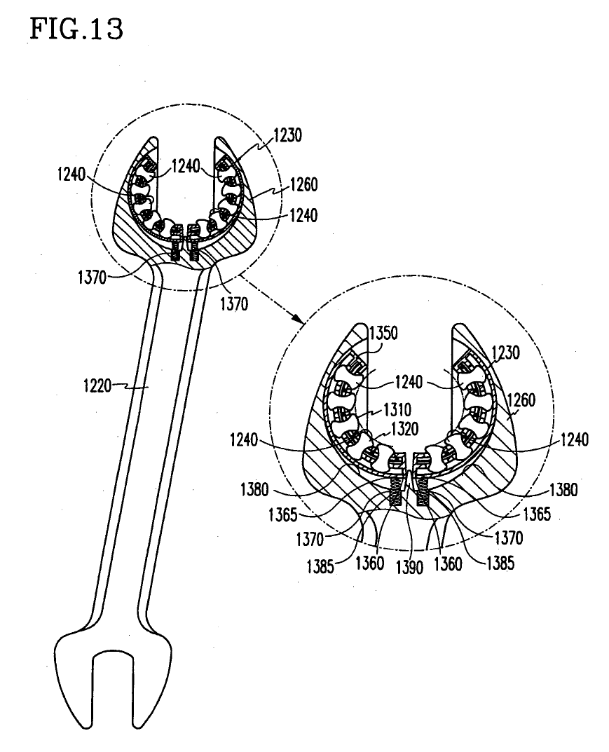

Each of the fastening units 1230 includes a plurality of sprags 1240. The fastening unit 1230 is outlined in FIG. 12, and its further detailed features are shown in FIG. 13.

FIG. 13 is a partial cross-sectional view of a wrench according to a fourth preferred embodiment of the present invention, the cross-section being perpendicular to an axis of its housing.

As shown in FIG. 13, ends 1310 of the sprags 1240, each end 1310 protruding toward the interior space 1205 of the housing 1210, form arcs 1320.

The fastening unit 1230 further includes a plate spring 1330, an inner ring 1340, and an outer ring 1350, each for positioning the sprags 1240. Each of the sprags 1240, the plate spring 1330, the inner ring 1340, and the outer ring 1350, and their cooperative relationship, are the same as shown in FIGS. 6-8, as is the description referring thereto, excepting that the arcs 1320 do not form a full circle.

The wrench 1200 of the fifth embodiment of the present invention further includes an elastic member 1370 producing an elastic force such that a space between exterior ends 1350 of the pair of fastening units 1230 is widened.

For such operation, the elastic members 1370 are provided in a pair, each of the pair of the elastic members 1370 being respectively abutted by each of the fastening units 1230 near ends 1365 thereof, and each of the pair of the elastic members 1370 is abutted by the housing 1210.

The elastic member 1370 is embodied as a coil spring, and a guide hole 1385 for guiding the spring operation is formed at an interior circumference 1380 of the housing.

The elastic member 1370 is stored in the guide hole 1385 and produces a biasing force on the fastening unit 1230.

Accordingly, each of the fastening units 1230 is kept in the corresponding receiving area 1265 of the fastening jaw 1260 when the wrench 1200 is not being operated.

Between the pair of elastic members 1370, a protrusion 1390 is formed on the interior circumference 1380 of the housing 1210 such that the two fastening units 1230 are securely separated.

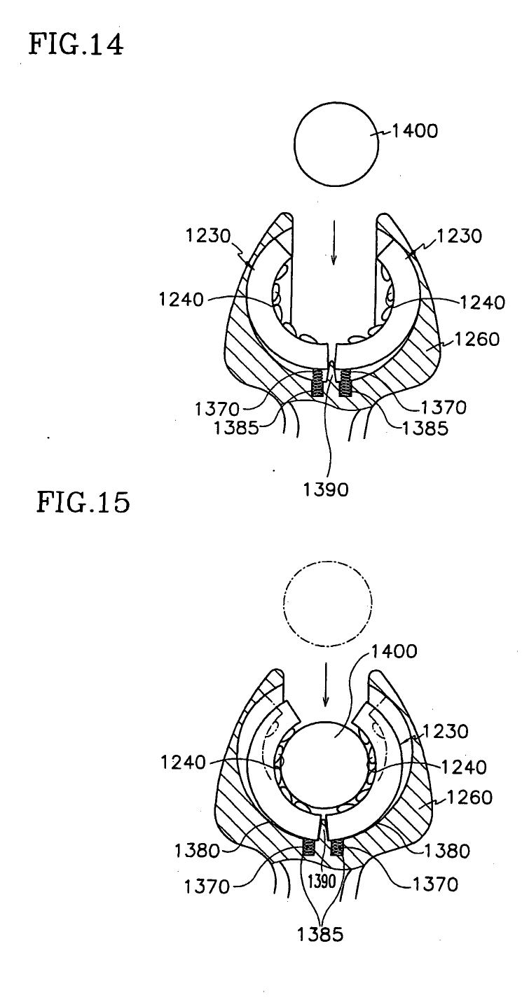

FIGS. 14 and 15 respectively show the wrench 1200, when not engaged and when engaged with a fastener, respectively.

In order to tighten or loosen a fastener 1400, the wrench 1200 is moved to the fastener 1400 such that the fastener 1400 is inserted between the facing fastening jaws 1260, and more specifically, between the facing fastening units 1230 of the fastening jaws 1260.

When the wrench 1200 is pushed toward the fastener 1400, the fastening unit 1230 is moved as shown in FIG. 15 such that the elastic members 1370 are compressed and accordingly the pair of fastening units 1230 encompass and tightly hold the fastener 1400.

In this case, when the wrench 1200 is rotated in the clockwise direction, the sprag 1240 operates the same as described above with reference to FIG. 9, and therefore clockwise torque is transmitted to the fastener 1400.

In the free stroke of the wrench 1200, the sprag 1240 operates the same as described above with reference to FIG. 10, and therefore the angular position of the wrench 1200 is changed and prepared for the subsequent power stroke without leaving free play.

According to a fastener such as a bolt and a nut of a preferred embodiment of the present invention, the same strength and durability can be achieved with a reduced exterior size because the circumference to receive tightening/loosening torque is either circular or polygonal with more than twelve angles.

Furthermore, the amount of material used for manufacturing a fastener is reduced. Accordingly, the weight of an assembly conjoined with use of the fasteners is reduced.

Drag resistance of air flow is also reduced when the assembly moves in the case that the circumference for receiving the tightening/loosening torque is exposed.

Particularly when the circumference of a fastener is circular, manufacturing process is simplified because the process of forming angles is not necessary, and therefore the manufacturing cost of a fastener is further reduced.

According to a wrench or socket for a socket wrench of a preferred embodiment of the present invention, a fastener having a circular circumference or a polygonal circumference of more than twelve angles can be easily tightened and loosened.

Furthermore, because free play does not occur during repetition of the power stroke and the free stroke, a fastener can be more easily tightened or loosened even when the space for operating a wrench is very small due to nearby obstacles.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A bolt comprising:
a body having a threaded portion; and
a bolt head extended from the body,
wherein a circumference of the bolt head is either circular or polygonal with more than twelve angles.

2. The bolt of claim 1, wherein an opposite side of the bolt head, opposite to the body, is flat or convex.

3. The bolt of claim 2, wherein a decoration groove is formed on the opposite side of the bolt head.

4. A nut having a threaded hole adapted to receive a bolt, wherein a circumference of the nut around an axis of the threaded hole is circular or polygonal with more than twelve angles.

5. The nut of claim 4, wherein the circumference is formed throughout a width of the nut.

6. A wrench comprising:
a housing having an interior space;
a handle for supplying torque to the housing; and
one or more fastening units disposed in the interior space of the housing,
wherein:
the fastening unit comprises a plurality of sprags; and
ends of the sprags, each protruding toward the interior space of the housing, form an arc.

7. The wrench of claim 6, wherein the fastening unit further comprises a plate spring for positioning the sprags.

8. The wrench of claim 7, wherein:
both lateral sides of the sprag are concave;
a plurality of receiving holes are formed at the plate spring;
each sprag is inserted through a receiving hole of the plate spring; and
a supporting projection is formed at the receiving hole of the plate spring such that the support projection supports the concave lateral side.

9. The wrench of claim 6, wherein at least one end of each sprag is asymmetrically convex.

10. The wrench of claim 6, wherein at least one end of each sprag is symmetrically convex.

11. The wrench of claim 6, wherein upper and lower edges of at least one end of each sprag are round.

12. The wrench of claim 6, wherein:
the fastening unit further comprises an inner ring and an outer ring for positioning the sprags;
a plurality of receiving holes are respectively formed at the inner ring and the outer ring;
the inner ring is disposed toward the interior space from the plate spring; and
the outer ring is disposed toward the opposite of the interior space from the plate spring.

13. The wrench of claim 6, wherein:
the interior space of the housing and the fastening unit are circularly formed; and
the arc formed by the ends of the sprags is a full circle.

14. The wrench of claim 6, wherein:
the interior space of the housing is opened to an exterior of the housing; and
the fastening unit is provided as a pair, each being disposed in the interior space of the housing, facing each other.

15. The wrench of claim 14 further comprising one or more elastic members producing an elastic force such that a space between exterior ends of the pair of fastening units is widened.

16. The wrench of claim 15, wherein:
the elastic member is provided in at least a pair;
each of the pair of the elastic members is respectively abutted by each of the fastening units; and
each of the pair of the elastic members is abutted by the housing.

17. A socket for a wrench socket comprising:
a housing having an interior space; and
a circular fastening unit, being disposed in the interior space of the housing,
wherein:
the fastening unit comprises a plurality of sprags; and
ends of the sprags, each protruding toward the interior space of the housing, form a circle.

18. The socket of claim 17, wherein at least one end of each sprag is asymmetrically convex.

19. The socket of claim 17, wherein upper and lower edges of at least one end of each sprag are round.

20. A fastener having a circumference for receiving torque, wherein the circumference is either circular or polygonal with more than twelve angles.
